(19) United States
(12) Patent Application Publication
(10) Pub. No.: US 2026/0117998 A1
(43) Pub. Date: Apr. 30, 2026

(54) SOLAR POWERED BATHROOM VENTILATION DEVICE

(71) Applicant: Mark Hollis, Corona, CA (US)

(72) Inventor: Mark Hollis, Corona, CA (US)

(21) Appl. No.: 18/931,752

(22) Filed: Oct. 30, 2024

(51) Int. Cl. F24F 7/013; H02S 20/23

(52) U.S. Cl. CPC F24F 7/013; H02S 20/23

(57) ABSTRACT

a Solar Powered Bathroom Ventilation Device Includes an Intake Vent which is Mountable to a Ceiling of a Bathroom to Enable Air to Pass into the Intake Vent for Removing Unpleasant Odors from the Bathroom. An Exhaust Duct is Fluidly Coupled to the Intake Vent and the Exhaust Duct is Routed to Extend Through an Exterior Wall of a Building in which the Bathroom is Located to Direct the Unpleasant Odors Outwardly from the Building. a Blower is Fluidly Attached to the Exhaust Duct to Urge the Air in the Exhaust Duct Outwardly Through the Blower when the Blower is Turned on for Ventilating the Unpleasant Odors from the Bathroom. a Solar Panel is Mounted to a Roof of the Building in which the Bathroom is Located for Supplying Electrical Power to the Blower.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to bathroom ventilation devices and more particularly pertains to a new bathroom ventilation device for ventilating unpleasant odors from a bathroom through an exterior wall of a building rather than through the roof of the building. The device includes an intake vent that is mountable to a ceiling of a bathroom and an exhaust duct that is routed through an exterior wall of a building which is shared with the bathroom. The device includes a blower that is attached to the exhaust duct for urging air from the intake vent and outwardly through the exhaust duct to ventilate unpleasant odors from the bathroom. The device includes a solar panel that is mountable to a roof of the building and a power cord that extends between the solar panel and the blower.

### (2) Description of Related Art Including Information Disclosed Under 37 CFR 1.97 and 1.98

The prior art relates to bathroom ventilation devices including a variety of solar powered ventilation devices that each at least includes a roof penetrating exhaust duct for ventilating the interior of an enclosed structure and a solar powered blower device that includes a solar panel and a blower that is electrically coupled to the solar panel for ventilating a building and an airflow system that includes a wall penetration hole and a port manifold for receiving a plurality of fan systems to be fluidly coupled to the wall penetration hole for ventilating moisture and biological spores from a structure. In no instance does the prior art disclose a wall penetrating ventilation device that includes an intake vent that is attachable to a ceiling of a bathroom and an exhaust duct that is routed through an exterior wall of a building in which the bathroom is located and a blower attached to the exhaust duct for ventilating the bathroom and a solar panel for supplying electrical power to the blower.

### (h) BRIEF SUMMARY OF THE INVENTION

An embodiment of the disclosure meets the needs presented above by generally comprising an intake vent which is mountable to a ceiling of a bathroom to enable air to pass into the intake vent for removing unpleasant odors from the bathroom. An exhaust duct is fluidly coupled to the intake vent and the exhaust duct is routed to extend through an exterior wall of a building in which the bathroom is located to direct the unpleasant odors outwardly from the building. A blower is fluidly attached to the exhaust duct to urge the air in the exhaust duct outwardly through the blower when the blower is turned on for ventilating the unpleasant odors from the bathroom. A solar panel is mounted to a roof of the building in which the bathroom is located for supplying electrical power to the blower.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a solar powered bathroom ventilation device according to an embodiment of the disclosure.

FIG. 2 is an exploded perspective view of an embodiment of the disclosure.

FIG. 3 is an exploded perspective view of a blower and an exhaust duct of an embodiment of the disclosure.

FIG. 4 is a phantom perspective view of a blower of an embodiment of the disclosure.

FIG. 5 is a perspective view of an intake vent of an embodiment of the disclosure.

FIG. 6 is a perspective in-use view of an embodiment of the disclosure.

### (j) DETAILED DESCRIPTION OF THE INVENTION

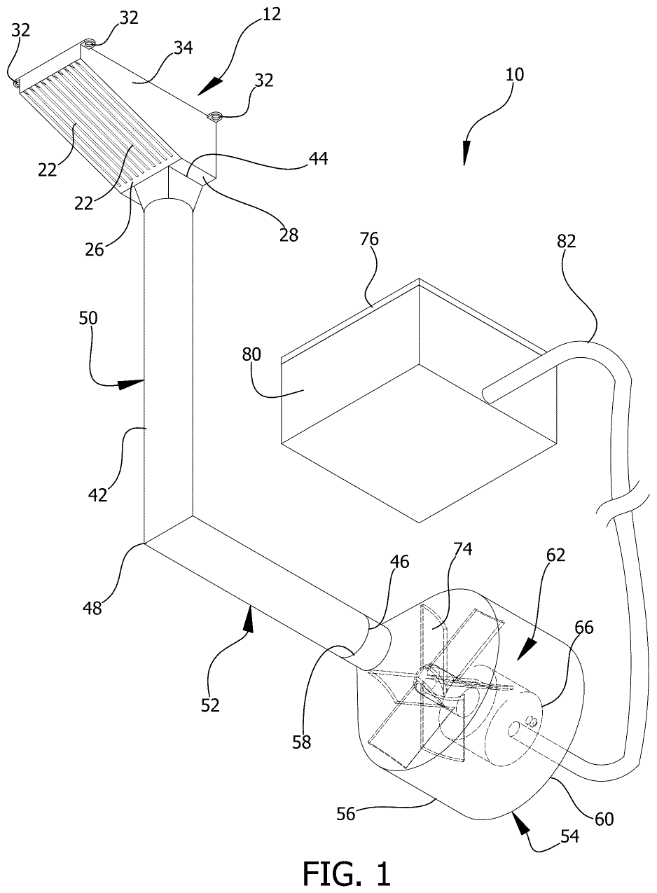

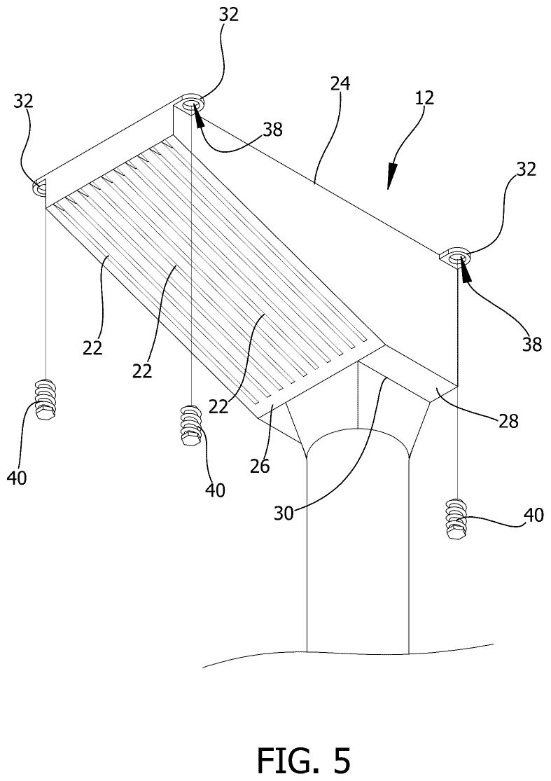

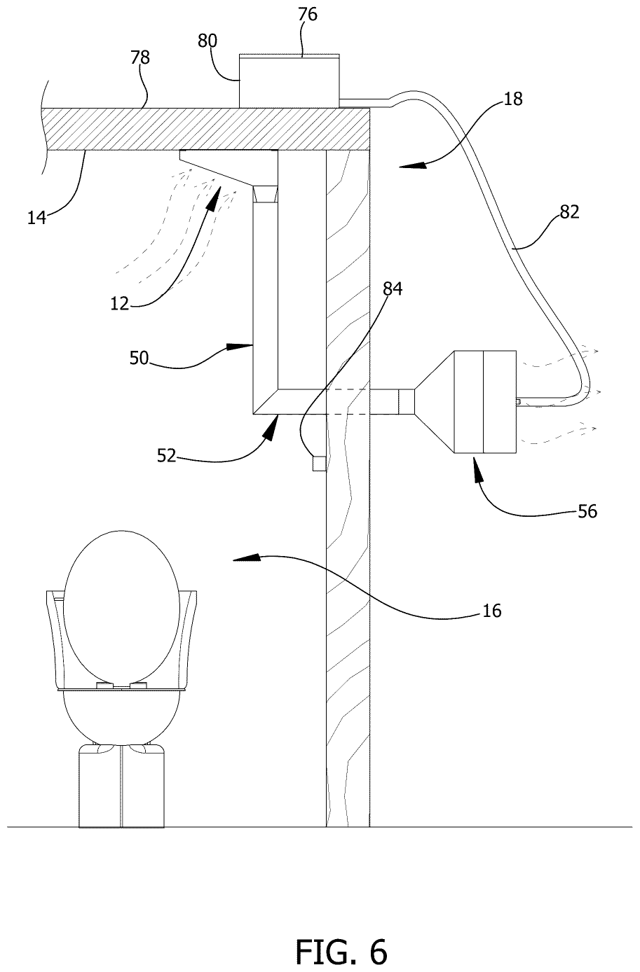

With reference now to the drawings, and in particular to FIGS. 1 through 6 thereof, a new bathroom ventilation device embodying the principles and concepts of an embodiment of the disclosure and generally designated by the reference numeral 10 will be described.

As best illustrated in FIGS. 1 through 6, the solar powered bathroom ventilation device 10 generally comprises an intake vent 12 is mountable to a ceiling 14 of a bathroom 16. The bathroom 16 is located in a building 18 and at least one of the walls of the bathroom 16 is an exterior wall 20 of the building 18. The building 18 may be a house, an office building or any other type of occupancy. The intake vent 12 has a plurality of intake slots 22 each extending into an interior of the intake vent 12 to enable air to pass into the intake vent 12 for removing unpleasant odors from the bathroom 16. The intake vent 12 has a top wall 24 which rests against the ceiling 14 of the bathroom 16 and a slanted wall 26 which is oriented at a downward slope with respect to the top wall 24 and each of the plurality of intake slots 22 extends through the slanted wall 26. Each of the plurality of intake slots 22 is elongated to extend along a substantial length of the slanted wall 26 and the intake slots 22 are evenly spaced apart from each other and are distributed across a substantial width of the slanted wall 26.

The intake vent 12 has a bottom wall 28 which intersects the slanted wall 26 and the bottom wall 28 lies on a plane which is oriented parallel to the top wall 24. The bottom wall 28 has an air opening 30 extending into the interior of the intake vent 12 pass air outwardly from the intake vent 12. The intake vent 12 has a plurality of tabs 32 each coupled to and extending laterally away from a perimeter edge 34 of the top wall 24 and each of the plurality of tabs 32 is aligned with a respective one of four corners 36 of the perimeter edge 34. Furthermore, each of the plurality of tabs 32 has a hole 38 extending through a respective tab 32 thereby enabling a respective one of a plurality of fasteners to be extended through the hole 38 in each of the plurality tabs 32 thereby enabling each of the plurality of fasteners 40 to extend into the ceiling 14 for retaining the intake vent 12 on the ceiling 14. The plurality of fasteners 40 may comprise screws, drywall anchors or other type of penetrating fastener.

An exhaust duct 42 is provided which is fluidly coupled to the intake vent 12 to receive the air that passes through the intake vent 12. The exhaust duct 42 is routed to extend through an exterior wall 20 of the building 18 in which the bathroom 16 is located to direct the unpleasant odors outwardly from the building 18. The exhaust duct 42 has a first end 44 and a second end 46 and the exhaust duct 42 is flared adjacent to the first end 44. The first end 44 is attached to the bottom wall 28 of the intake vent 12 having the first end 44 being aligned with the air opening 30 in the bottom wall 28 to receive the air in the intake vent 12. Additionally, the exhaust duct 42 has a bend 48 which is located between the first end 44 and the second end 46 to define a first portion 50 of the exhaust duct 42 that is oriented at an angle with a second portion 52 of the exhaust duct 42. The first end 44 is associated with the first portion 50 and the second end 46 is associated with the second portion 52. Furthermore, the first portion 50 extends downwardly from the intake vent 12 and the second portion 52 extends through the exterior wall 20 of the building 18 such that the second end 46 is positioned outside of the building 18.

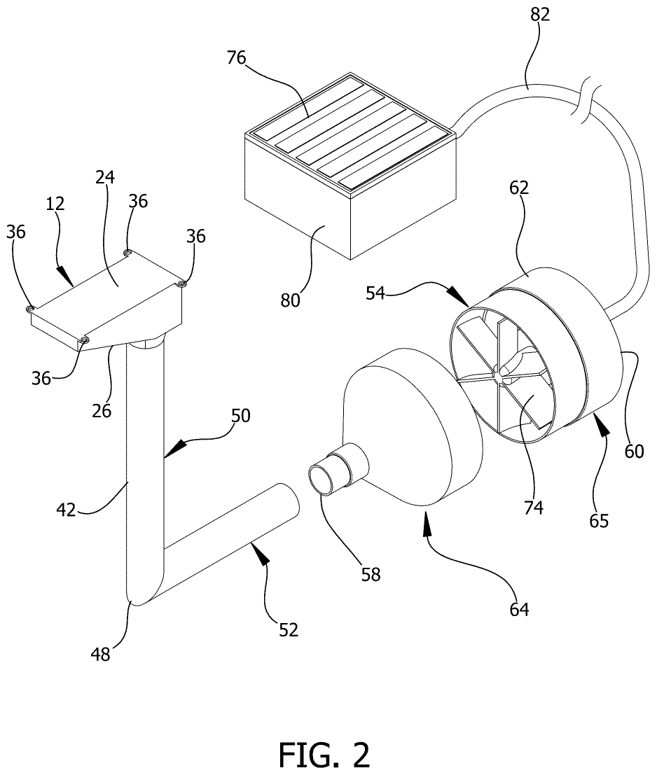

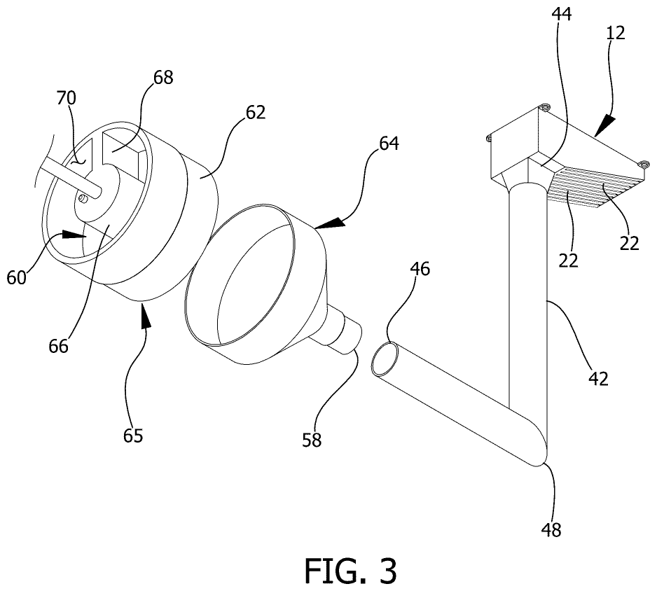

A blower 54 is fluidly attached to the exhaust duct 42 to enable the blower 54 to urge the air in the exhaust duct 42 outwardly through the blower 54 when the blower 54 is turned on for ventilating the unpleasant odors from the bathroom 16. The blower 54 comprises a housing 56 which has an inlet 58 and an outlet 60 and an outer wall 62 extending between the inlet 58 and the outlet 60. The outer wall 62 tapers adjacent to the inlet 58 such that the inlet 58 has a diameter that is less than a diameter of the outlet 60 such that the outer wall 62 of the housing 56 defines a funnel 64 that is associated with the inlet 58. Each of the inlet 58 and the outlet 60 is open to pass air through the housing 56. Additionally, the inlet 58 is fluidly coupled to the second end 46 of the exhaust duct 42 such that the housing 56 is positioned outside of the building 18. As is most clearly shown in FIGS. 2 and 3, the housing 56 may be divided such that the funnel 64 is removable from a rear portion 65 of the housing 56.

The blower 54 includes a motor 66 which is mounted within the housing 56 and the motor 66 includes a mount 68 which is attached to an inside surface 70 of the outer wall 62 of the housing 56 thereby suspending the motor 66 from the inside surface 70. The mount 68 is aligned with the outlet 60 of the housing 56 and the motor 66 has a drive shaft 72 which rotates in a first direction when the motor 66 is turned on. The motor 66 may comprise a single direction electric motor or the like. The blower 54 includes a fan 74 which is attached to the drive shaft 72 to urge air outwardly through the outlet 60 of the housing 56 when the motor 66 is turned on. In this way the fan 74 is enabled to ventilate the unpleasant odors from the housing 56 when the motor 66 is turned on.

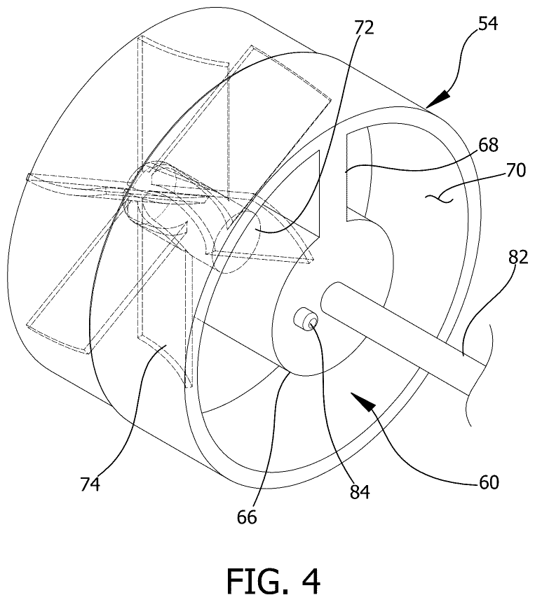

A solar panel 76 is mounted to a roof 78 of the building 18 in which the bathroom 16 is located such that the solar panel 76 is exposed to sunlight. Furthermore, the solar panel 76 may be attached to a box 80 which is mounted to the roof 78 of the building 18. The solar panel 76 is in communication with the blower 54 for supplying electrical power to the blower 54. A power cord 82 is electrically coupled between the solar panel 76 and the motor 66. Additionally, the power cord 82 is comprised of an electrically conductive material thereby enabling the power cord 82 to transfer electrical energy from the solar panel 76 to the motor 66. A switch 84 is provided and the switch 84 may be located within the bathroom 16 and the switch 84 is electrically coupled to the motor 66. In this way the motor 66 can be turned on and off from within the bathroom 16. Additionally, as is most clearly shown in FIG. 4, the switch 84 may be located on the motor 66 itself to enable to motor 66 to be turned on and off from outside of the building 18. Electrical wiring is routed through the exterior wall 20 of the building 18 between the switch 84 and the motor 66 in the event that the switch 84 is located within the bathroom 16.

In use, the intake vent 12 is mounted to the ceiling 14 of the bathroom 16 and the exhaust duct 42 is routed through the exterior wall 20 of the building 18 to locate the blower 54 outside of the building 18. Electrical wiring is routed through the exterior wall between the switch 84 and the motor 66 when the switch 84 is located within the bathroom 16 to enable the motor 66 to be controlled from within the bathroom 16. The solar panel 76 is mounted to the roof 78 the building 18 using best practices to supply electrical power to the motor 66 of the blower 54. In this way the blower 54 can be turned on to ventilate unpleasant odors from the bathroom 16 without being required to penetrate the roof 78 of the building 18 with ducting as is commonly required with bathroom ventilation systems. However, the bathroom 16 must share an exterior wall 20 of the building 18 in order for the exhaust duct 42 to be effectively routed to the outside of the building 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar powered bathroom ventilation device for ventilating unpleasant odors from a bathroom in a building, said device comprising:
an intake vent being mountable to a ceiling of a bathroom, said intake vent having a plurality of intake slots each extending into an interior of said intake vent wherein each of said plurality of intake slots is configured to enable air to pass into said intake vent for removing unpleasant odors from said bathroom;
an exhaust duct being fluidly coupled to said intake vent wherein said exhaust duct is configured to receive the air that passes through said intake vent, said exhaust duct being routed to extend through an exterior wall of a building in which said bathroom is located wherein said exhaust duct is configured to direct the unpleasant odors outwardly from said building;
a blower being fluidly attached to said exhaust duct wherein said blower is configured to urge the air in said exhaust duct outwardly through said blower when said blower is turned on for ventilating the unpleasant odors from said bathroom; and
a solar panel being mounted to a roof of said building in which said bathroom is located wherein said solar panel is configured to be exposed to sunlight, said solar panel being in communication with said blower for supplying electrical power to said blower.

2. The device according to claim 1, wherein:
said intake vent has a top wall which rests against said ceiling of said bathroom and a slanted wall which is oriented at a downward slope with respect to said top wall;
each of said plurality of intake slots extends through said slanted wall;
each of said plurality of intake slots is elongated to extend along a substantial length of said slanted wall;
said plurality of intake slots is evenly spaced apart from each other and is distributed across a substantial width of said slanted wall;
said intake vent has a bottom wall which intersects said slanted wall having said bottom wall lying on a plane being oriented parallel to said top wall;
said bottom wall has an air opening extending into said interior of said intake vent wherein said air opening is configured to pass air outwardly from said intake vent;
said intake vent has a plurality of tabs each being coupled to and extending laterally away from a perimeter edge of said top wall;
each of said plurality of tabs is aligned with a respective one of four corners of said perimeter edge; and
each of said plurality of tabs has a hole extending through a respective tab thereby enabling a respective one of a plurality of fasteners to be extended through said hole in each of said plurality tabs thereby enabling each of said plurality of fasteners to extend into said ceiling for retaining said intake vent on said ceiling.

3. The device according to claim 2, wherein:
said exhaust duct has a first end and a second end;
said exhaust duct is flared adjacent to said first end;
said first end is attached to said bottom wall of said intake vent having said first end being aligned with said air opening in said bottom wall wherein said first end is configured to receive the air in said intake vent;
said exhaust duct has a bend being located between said first end and said second end to define a first portion of said duct being oriented at an angle with a second portion of said exhaust duct;
said first end is associated with said first portion;
said second end is associated with said second portion;
said first portion extends downwardly from said intake vent; and
said second portion extends through said exterior wall of said building such that said second end is positioned outside of said building.

4. The device according to claim 3, wherein:
said blower comprises a housing having an inlet and an outlet and an outer wall extending between said inlet and said outlet;
said outer wall tapers adjacent to said inlet such that said inlet has a diameter that is less than a diameter of said outlet;
each of said inlet and said outlet is open wherein said housing is configured to pass air through said housing; and
said inlet is fluidly coupled to said second end of said exhaust duct such that said housing is positioned outside of said building.

5. The device according to claim 1, wherein:
said blower includes a housing having an outer wall and an outlet;
said blower includes a motor being mounted within said housing;
said motor includes a mount which is attached to an inside surface of said outer wall of said housing thereby suspending said motor from said inside surface;
said mount is aligned with said outlet of said housing;
said motor having a drive shaft which rotates in a first direction when said motor is turned on; and
said blower includes a fan being attached to said drive shaft wherein said fan is configured to urge air outwardly through said outlet of said housing when said motor is turned on thereby enabling said fan to ventilate the unpleasant odors from said housing when said motor is turned on.

6. The device according to claim 5, wherein:
said device includes a power cord being electrically coupled between said solar panel and said motor;
said power cord is comprised of an electrically conductive material thereby enabling said power cord to transfer electrical energy from said solar panel to said motor.

7. A solar powered bathroom ventilation device for ventilating unpleasant odors from a bathroom in a building, said device comprising:
an intake vent being mountable to a ceiling of a bathroom, said intake vent having a plurality of intake slots each extending into an interior of said intake vent wherein each of said plurality of intake slots is configured to enable air to pass into said intake vent for removing unpleasant odors from said bathroom, said intake vent having a top wall which rests against said ceiling of said bathroom and a slanted wall which is oriented at a downward slope with respect to said top wall, each of said plurality of intake slots extending through said slanted wall, each of said plurality of intake slots being elongated to extend along a substantial length of said slanted wall, said plurality of intake slots being evenly spaced apart from each other and being distributed across a substantial width of said slanted wall, said intake vent having a bottom wall which intersects said slanted wall having said bottom wall lying on a plane being oriented parallel to said top wall, said bottom wall having an air opening extending into said interior of said intake vent wherein said air opening is configured to pass air outwardly from said intake vent, said intake vent having a plurality of tabs each being coupled to and extending laterally away from a perimeter edge of said top wall, each of said plurality of tabs being aligned with a respective one of four corners of said perimeter edge, each of said plurality of tabs having a hole extending through a respective tab thereby enabling a respective one of a plurality of fasteners to be extended through said hole in each of said plurality tabs thereby enabling each of said plurality of fasteners to extend into said ceiling for retaining said intake vent on said ceiling;
an exhaust duct being fluidly coupled to said intake vent wherein said exhaust duct is configured to receive the air that passes through said intake vent, said exhaust duct being routed to extend through an exterior wall of a building in which said bathroom is located wherein said exhaust duct is configured to direct the unpleasant odors outwardly from said building, said exhaust duct having a first end and a second end, said exhaust duct being flared adjacent to said first end, said first end being attached to said bottom wall of said intake vent having said first end being aligned with said air opening in said bottom wall wherein said first end is configured to receive the air in said intake vent, said exhaust duct having a bend being located between said first end and said second end to define a first portion of said duct being oriented at an angle with a second portion of said exhaust duct, said first end being associated with said first portion, said second end being associated with said second portion, said first portion extending downwardly from said intake vent, said second portion extending through said exterior wall of said building such that said second end is positioned outside of said building;
a blower being fluidly attached to said exhaust duct wherein said blower is configured to urge the air in said exhaust duct outwardly through said blower when said blower is turned on for ventilating the unpleasant odors from said bathroom, said blower comprising:
a housing having an inlet and an outlet and an outer wall extending between said inlet and said outlet, said outer wall tapering adjacent to said inlet such that said inlet has a diameter that is less than a diameter of said outlet, each of said inlet and said outlet being open wherein said housing is configured to pass air through said housing, said inlet being fluidly coupled to said second end of said exhaust duct such that said housing is positioned outside of said building;
a motor being mounted within said housing, said motor including a mount which is attached to an inside surface of said outer wall of said housing thereby suspending said motor from said inside surface, said mount being aligned with said outlet of said housing, said motor having a drive shaft which rotates in a first direction when said motor is turned on; and
a fan being attached to said drive shaft wherein said fan is configured to urge air outwardly through said outlet of said housing when said motor is turned on thereby enabling said fan to ventilate the unpleasant odors from said housing when said motor is turned on;
a solar panel being mounted to a roof of said building in which said bathroom is located wherein said solar panel is configured to be exposed to sunlight, said solar panel being in communication with said blower for supplying electrical power to said blower; and
a power cord being electrically coupled between said solar panel and said motor, said power cord being comprised of an electrically conductive material thereby enabling said power cord to transfer electrical energy from said solar panel to said motor.
